(19) United States
(12) Patent Application Publication
(10) Pub. No.: US 2002/0073082 A1
(43) Pub. Date: Jun. 13, 2002

(54) System modification processing technique implemented on an information storage and retrieval system

(76) Inventors: Edouard Duvillier, Mountain View, CA (US); Didier Cabannes, Burlingame, CA (US)

Correspondence Address: BEYER WEAVER & THOMAS LLP, P.O. BOX 778, BERKELEY, CA, 94704-0778, US

(21) Appl. No.: 09/990,524

(22) Filed: Nov. 20, 2001

Related U.S. Application Data
(63) Continuation-in-part of application No. 09/736,039, filed on Dec. 12, 2000.

(51) Int. Cl. G06F 7/00

(52) U.S. Cl. 707/3

(57) ABSTRACT

A technique is disclosed for implementing system modification operations in an information storage and retrieval system. The information storage and retrieval system includes persistent memory configured or designed to store object data. The persistent memory includes at least one data file for storing object data. A first system modification request relating to a first data file is received, the first data file including a first object stored therein. The first system modification request is then implemented. According to a specific embodiment, the implementation of the first system modification request includes suspending write access to the first data file. Concurrently, while the first system modification request is being implemented, updated information relating to the first object may be stored in the persistent memory. According to a specific embodiment, the information storage and retrieval system corresponds to a non-positional, non-log based information storage and retrieval system. According to different embodiments, the information storage and retrieval system of the present invention may be configured to handle a variety of different system modification requests, including, for example, a request to add a mirror data file to be associated with a primary data file, a request to take the primary data file off-line, a request to take the mirror data file off-line. Moreover, according to a specific implementation, the implementing of the first system modification request may performed in real-time, without blocking access to object data stored in the persistent memory.

### RELATED APPLICATION DATA

This application is a continuation-in-part of U.S. pat. application Ser. No. 09/736,039 to Duvillier et al., filed on Dec. 12, 2000 (herein referred to as the “Parent Application”), the entirety of which is incorporated herein by reference in its entirety for all purposes.

### BACKGROUND OF THE INVENTION

1. Field of the Invention

The present invention relates generally to information storage and retrieval systems, and more specifically to a system modification processing technique implemented on an intrinsic versioning, non-positional information storage and retrieval system.

2. Background

Over the past decade, advances in computer and network technologies have dramatically changed the degree and type of information to be saved by and retrieved from information storage and retrieval systems. As a result, conventional database systems are continually being improved to accommodate the changing needs of many of today's computer networks.

One common type of conventional information storage and retrieval system is the relational database management system (RDBMS), such as that shown, for example, in FIG. 1 of the drawings. The RDBMS system 100 of FIG. 1 utilizes a log-based system architecture for processing information storage and retrieval transactions. The log-based system architecture has become an industry standard, and is widely used in a variety of conventional RDBMS systems including, for example, IBM systems, Oracle systems, the well-known System R, etc.

Traditionally, the log-based system architecture was designed to handle many small or incremental update transactions for computer systems such as those associated with banks, or other financial institutions. According to conventional practice, when it is desired to record an update transaction using a conventional RDBMS system (such as that shown in FIG. 1), the transaction information is first passed to a data server 104, which then accesses a buffer table 106 to determine the physical memory location of where the update transaction information should be stored. Typically the buffer table 106 provides a mapping for translating a given data object with an associated physical address location in the database 120. Each time information in the RDBMS system is to be accessed, the data server 104 must first access the buffer table 106 in order to determine the physical address of the memory location where the desired information is located. Once the physical address of the desired memory location has been determined, the updated data object may then written to the database 120 over the previous version of that data object. Additionally, a log record of the update transaction is created and stored in the log file 122. The log file is typically used to keep track of changes or updates which occur in the database 120.

As stated previously, the log-based system architecture was originally designed for maintaining records of multiple small, discreet transactions. For example, the log-based system architecture is ideally suited for handling financial transactions such as a customer deposit to a banking account. Using this example for purposes of illustration, it will be assumed that the customer has an existing account balance which is stored in database 120 as Data Item C 120C. Each data item in the database 120 may be stored at a physically distinct location in the storage device of the database 120. Typically, the storage device is a high-capacity disk drive.

It is further assumed in this example that the customer makes a deposit to his or her banking account. When the deposit information is entered into the computer system, an updated account balance for the customer's account is calculated. The updated account balance information, which includes the customer banking account number, is then forwarded to the data server 104. Assuming that the disk address or row ID corresponding to Data Item C is already known (such as, for example, by performing an index traversal or a table lookup), the data server 104 then consults the buffer table 106 to determine the location in the memory cache 124 where information relating to the identified customer account is located. Once the memory location information has been obtained from the buffer table, the data server 104 then updates the account balance information in the memory cache. The cached Data Item C will eventually be updated in place in database 120 at the physical memory location allocated to Data Object C. As a result, the updated account balance information is written over the previous account balance information of that customer account (which had been stored at the disk address allocated to Data Object C). Additionally, for purposes of recovery protection, the deposit transaction information (e.g. deposit amount, disk address) is appended to a log file 122A.

A more detailed description of conventional RDBMS systems is provided in the document entitled “Oracle 8i Concepts”, release 8.1.5, February 1999, published by Oracle Corporation of Redwood City, Calif. That document is incorporated herein by reference in its entirety for all purposes.

It will be appreciated that the log-based architecture design of conventional RDBMS systems may result in a number of undesirable access and delay problems when handling large data transactions.

For example, one limitation of conventional RDBMS systems is that the relational nature of objects stored in the RDBMS system requires that all updates to a data object stored within the database 120 be written each time to the same physical location (e.g. disk space) where that object is stored. Because of this requirement, such systems are typically referred to as “positional” database systems since it is important that the relative position of each object stored in the database be maintained in order for the relational database to function properly. Moreover, when updates are being performed on portions of data stored within a positional database system, users will typically be unable to access any portion of the updated data until after the entirety of the data update has been completed. If the user attempts to access a portion of the data while the update is occurring, the user will typically experience a hanging problem, or will be handed dirty data (e.g. stale data) until the update transaction(s) have been completed.

In light of this problem, content providers typically resort to setting up a second data file (typically referred to as a “mirror” data file) which includes an identical copy of the information stored in the original or “primary” data file. In this way users are provided with the ability to access desired information from the mirror data file at times when the primary data file is off-line. However, it will be appreciated that such an approach demands a relatively large amount of resources for implementation, particularly with respect to memory resources.

Another limitation of conventional RDBMS systems relates to system down time which occurs, for example, during the back up of a primary data file and/or creation of a mirror data file. For example, when it is desired to physically remove a selected disk from the persistent memory, the data stored on the selected disk is typically transferred to a different disk to thereby allow access to the data after the selected disk has been removed from the persistent memory. This is illustrated, for example, in FIG. 2 of the drawings.

FIG. 2 shows a block diagram of a persistent memory subsystem 200 which may form part of a conventional RDBMS system. In the example of FIG. 2, the persistent memory 200 includes Disk A 160, Disk B 170, and a log file 180. As shown in FIG. 2, Disk A 160 includes inventory data 164 which is contained within Table Space A 162 of Disk A. Typically, when it is desired to physically remove Disk A from the persistent memory, the data stored within Disk A will be transferred to another disk (e.g. Disk B) in the persistent memory. In order to effect the transfer of data, all table spaces on Disk A are closed in order to disable access operations (e.g. read/writes) to Disk A. Data on Disk A may then be transferred to Disk B. After completion of the transfer of data, the Table Space A′ 172 on Disk B may be opened to allow access to the transferred data. Thereafter, Disk A may be removed from the system.

It will be appreciated that, during the above-described data transfer process, at least a portion of the persistent memory may be taken off-line in order to prevent users from accessing the system during the data transfer operations. The length of system down time will typically depend upon the size of the disk, and the amount of data stored therein. For example, several hours of down time may be needed to complete a data transfer of several gigabytes from one disk to another.

Similar problems to those described above are also encountered when initiating a data file mirroring technique in a conventional RDBMS system. As commonly known to one having ordinary skill in the art, a data file mirroring technique typically involves implementing and maintaining a second (i.e. “mirror”) disk in the persistent memory which mirrors data stored on a first or primary disk in the persistent memory. For example, referring to the configuration of FIG. 2, Disk B 170 may be configured as a mirror disk of Disk A 160, wherein the data stored in Disk B will be maintained to be continuously identical to the data stored in Disk A. According to conventional mirroring techniques, any updates to data stored in the primary disk will simultaneously be implemented on the corresponding data stored in the mirror disk.

When implementing a mirror data file in a conventional RDBMS system, the primary data file must be taken off-line in order to ensure successful implementation of the mirror data file. For example, referring to FIG. 2, if it is assumed that Disk B is to be implemented as a mirror of Disk A, then the contents of Disk A will need to be transferred to Disk B. In order to affect this transfer operation, all table spaces on Disk A are closed in order to disable access operations (e.g. read/writes) to Disk A. Data on Disk A may then be transferred to Disk B. After completion of the transfer of data, the Table Space A′ (on Disk B) and Table Space A (on Dick A) may be opened to allow access to the data.

Another limitation of conventional RDBMS systems is that, typically, conventional relational database software does not include the necessary code for implementing and managing mirror data files. Accordingly, third party software such as, for example, volume manager software manufactured by Veritas Software of Mountain View, Calif., are used to implement data file mirroring techniques on conventional relational database software. It will be appreciated that, in many situations, the use of third party software for providing data file mirroring functionality is undesirable since such a solution introduces other problems such as, for example, compatibility issues, service and maintenance issues, etc.

In light of the above, it will be appreciated that there is a continual need to improve upon information storage and retrieval techniques in order to accommodate new and emerging technologies and applications.

### SUMMARY OF THE INVENTION

According to different embodiments of the present invention, various methods, systems, and computer program products are disclosed for implementing system modification operations in an information storage and retrieval system. The information storage and retrieval system includes persistent memory configured or designed to store object data. The persistent memory includes at least one data file for storing object data. A first system modification request relating to a first data file is received, the first data file including a first object stored therein. The first system modification request is then implemented. According to a specific embodiment, the implementation of the first system modification request includes suspending write access to the first data file. Concurrently, while the first system modification request is being implemented, updated information relating to the first object may be stored in the persistent memory.

According to a specific embodiment, the information storage and retrieval system corresponds to a non-positional, non-log based information storage and retrieval system. According to different embodiments, the information storage and retrieval system of the present invention may be configured to handle a variety of different system modification requests, including, for example, a request to add a mirror data file to be associated with a primary data file, a request to take the primary data file off-line, a request to take the mirror data file off-line. Moreover, according to a specific implementation, the implementing of the first system modification request may performed in real-time, without blocking access to object data stored in the persistent memory.

Alternate embodiments of the present invention are directed to a method and system for implementing system modification operations in an information storage and retrieval system. The information storage and retrieval system includes persistent memory configured or designed to store object data. The persistent memory includes a first data file and a second data file, wherein the first data file includes first object data stored therein. A first system modification request to remove the first data file from the persistent memory is received. Removal of the first data file from the persistent memory is then implemented. Concurrently, during the removal of the first data file continuous access to object data stored in the persistent memory is provided. Additionally, according to a specific embodiment, continuous data update access to the first object data may also be provided concurrently during the removal of the first data file. According to a specific implementation, the information storage and retrieval system may correspond to a non-positional, non-log based information storage and retrieval system. Additionally, according to a specific implementation, the removal of the first data file from the persistent memory may be accomplished in real-time without taking the information storage and retrieval system off-line.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 shows a conventional information storage and retrieval system implemented as relational database management system (RDBMS).

FIG. 2 shows a block diagram of a persistent memory subsystem 200 which may form part of a conventional RDBMS system.

FIG. 3 shows a schematic block diagram of an information storage and retrieval system 300 in accordance with a specific embodiment of the present invention.

FIG. 4 shows a specific embodiment of a flow diagram illustrating the interaction between different components of an information storage and retrieval system 400 during implementation of a specific embodiment of the mirroring technique of the present invention.

FIG. 5 shows a flow diagram of a Remove Mirror Procedure 500 in accordance with a specific embodiment of the present invention.

FIG. 6 shows a flow diagram of a Remove Primary Procedure 600 in accordance with a specific embodiment of the present invention.

FIG. 7 shows a flow diagram of an Add Mirror Procedure 700 in accordance with a specific embodiment of the present invention.

FIG. 8A shows a specific embodiment of a block diagram of a disk page buffer 800, in accordance with a specific embodiment of the present invention.

FIG. 8B shows a block diagram of a version of a database object 880 in accordance with a specific embodiment of the present invention.

FIG. 9A shows a block diagram of a specific embodiment of a virtual memory system 900 which may be used to implement an optimized block write feature of the present invention.

FIG. 9B shows a block diagram of a writer thread 990 in accordance with a specific embodiment of the present invention.

FIG. 10 shows a flow diagram of a Cache Manager Flush Procedure 1000 in accordance with a specific embodiment of the present invention.

FIG. 11A shows a flow diagram of a Disk Manager Flush Procedure 1100 in accordance with a specific embodiment of the present invention.

FIG. 11B shows a flow diagram of a Callback Procedure 1150 in accordance with a specific embodiment of the present invention.

FIG. 12 shows a flow diagram of a Remove Non-Mirrored Data File procedure 1200 in accordance with a specific embodiment of the present invention.

FIG. 13 shows a flow diagram of a LEVEL_MAX Version Collection procedure 1300 in accordance with a specific embodiment of the present invention.

FIG. 14 shows a block diagram illustrating an example of various writer thread data structures 1400 in according with a specific embodiment of the present invention.

FIG. 15 shows a specific embodiment of a block diagram illustrating how different portions of the Object Table 1501 maybe stored within the information storage and retrieval system of the present invention.

FIG. 16 shows a specific embodiment of a network device 10 suitable for implementing various aspects of the information storage and retrieval techniques of the present invention.

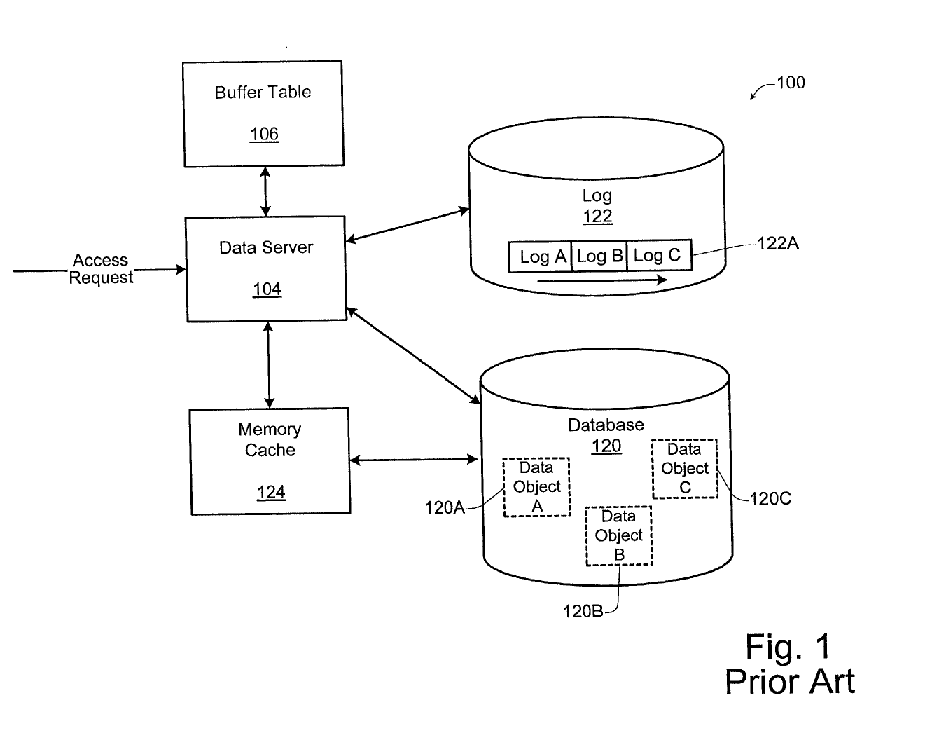

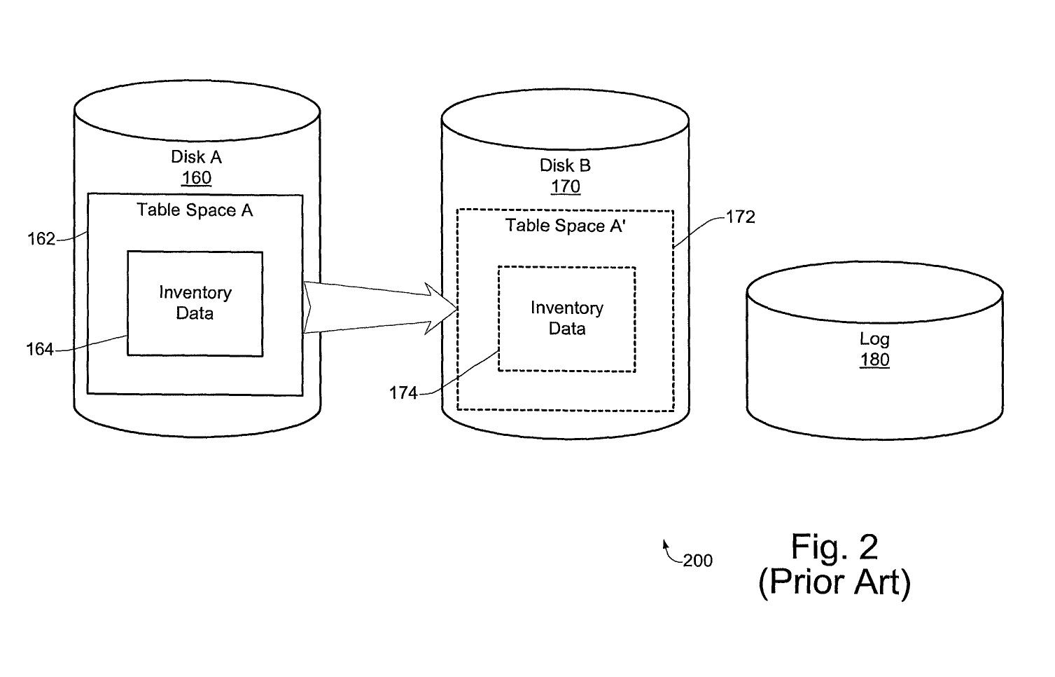

### DETAILED DESCRIPTION OF THE PREFERRED EMBODIMENTS

According to various embodiments of the present invention, a database system modification processing technique is described which may be implemented, for example, in information storage and retrieval systems such as that described in the Parent Application. As will be appreciated from the detailed description below, the system modification processing technique of the present invention provides a number of advantages over conventional system modification processing techniques which are implemented on conventional RDBMS systems. For example, the system modification processing technique of the present invention allows mirror data files to be automatically implemented in specific information storage and retrieval systems without requiring the use of third party software, thereby providing an integrated solution to data management. Another advantage of the system modification processing technique of the present invention is that the addition and/or removal of a mirror data file and/or a primary data file may be implemented without requiring system down time during execution of such operations. Additionally, the creation and/or removal of a mirror data files or primary data files may be performed without blocking write access or data updates to data stored within the database.

In order to gain a better understanding of the various aspects of the present invention, it will be helpful to briefly review certain aspects of the information storage and retrieval system described in the Parent Application.

In U.S. patent application Ser. No. 09/736,039, a non-log based information storage and retrieval system is described. The non-log based information storage and retrieval system described in the Parent Application provides for intrinsic versioning of objects stored in a database. According to specific embodiments, an object stored in the database may be identified using a corresponding object ID associated with that particular object. Each object may have one or more versions (herein referred to as “object versions”) associated therewith, which are also stored in the database. Each object version may be identified by a respective version ID. Thus, for example, when a new version of a particular object is stored in the database, the new version is assigned a unique version ID in order to differentiate that object version from other, previous versions of the same object.

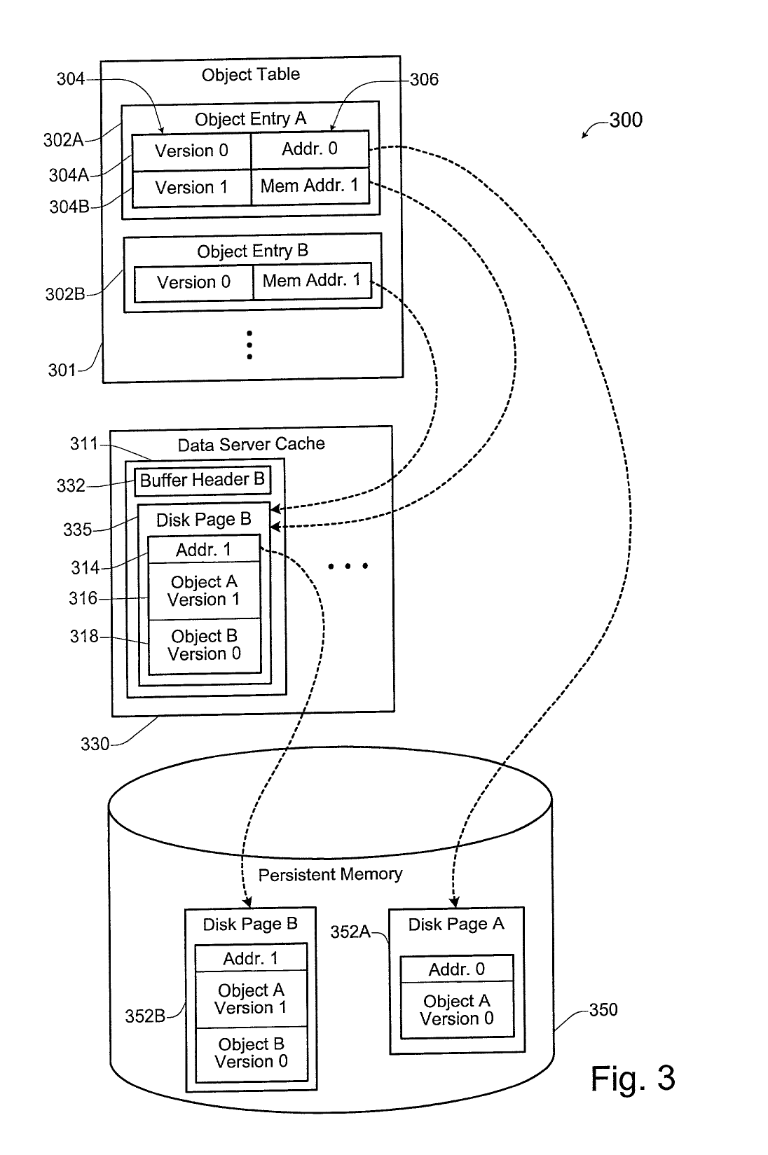

FIG. 3 shows a schematic block diagram of an information storage and retrieval system 300 in accordance with a specific embodiment of the present invention. As shown in FIG. 3, the system 300 includes a number of internal structures which provide a variety of information storage and retrieval functions, including, for example, the translation of logical object IDs to physical locations where the objects are stored. The main structures of the database system 300 of FIG. 3 include at least one Object Table 301, at least one data server cache such as data server cache 330, and at least one persistent memory database 350 such as, for example, a disk drive.

As shown in FIG. 3, the Object Table 301 may include a plurality of entries (e.g. 302A, 302B, etc.). Each entry in Object Table 301 may be associated with one or more versions of objects stored in the database. For example, in the embodiment of FIG. 3, Object Entry A (302A) is associated with a particular object identified as Object A. Additionally, Object Entry B (302B) is associated with a different object stored in the database, identified as Object B. As shown in Object Table 301, Object A has 2 versions associated with it, namely Version 0 (304A) and Version 1 (304B). In the example of FIG. 3, it is assumed that Version 1 corresponds to a more recent version of Object A than Version 0. Object Entry B represents a single version object wherein only a single version of the object (e.g. Object B, Version 0) is stored in the database.

According to a specific implementation, the version ID values which are assigned to the various object versions in the database may represent logical time reference values. In such embodiments, the version ID values may be used to determine the relative age of one or more object versions relative to a given version ID value. For example, according to one implementation, the version ID values may be assigned in a sequential manner to all atomically committed transactions.

As shown in the embodiment of FIG. 3, each version of each object identified in Object Table 301 is stored within the persistent memory data structure 350, and may also be stored in the data server cache 330. More specifically, Version 0 of Object A is stored on a disk page 352A (Disk Page A) within data structure 350 at a physical memory location corresponding to “Address 0”. Version 1 of Object A is stored on a disk page 352B (Disk Page B) within data structure 350 at a physical memory location corresponding to “Address 1”. Additionally, as shown in FIG. 3, Version 0 of Object B is also stored on Disk Page B within data structure 350.

When desired, one or more selected object versions may also be stored in the data server cache 330. According to a specific embodiment, the data server cache may be configured to store copies of selected disk pages located in the persistent memory 350. For example, as shown in FIG. 3, data server cache 330 includes at least one disk page buffer 311 which includes a buffer header 332, and a copy 335 of Disk Page B 352B. The copy of Disk Page B includes both Version 1 of Object A (316), and Version 0 of Object B (318).

As shown in FIG. 3, each object version represented in Object Table 301 includes a corresponding address 306 which may be used to access a copy of that particular object version which is stored in the database system 300. According to a specific embodiment, when a particular copy of an object version is stored in the data server cache 330, the address portion 306 of that object version (in Object Table 301) will correspond to the memory address of the location where the object version is stored in the data server cache 330. Thus, for example, as shown in FIG. 3, the address corresponding to Version 1 of Object A in Object Table 301 is Memory Address 1, which corresponds to the disk page 335 (residing in the data server cache) that includes a copy of Object A, Version 1 (316). Additionally, the address corresponding to Version 0 of Object B (in Object Table 301) is also Memory Address 1 since Disk Page B 335 also includes a copy of Object B, Version 0 (318).

As shown in FIG. 3, Disk Page B 335 of the data server cache includes a separate address field 314 which points to the memory location (e.g. Addr. 1) where the Disk Page B 352B is stored within the persistent memory data structure 350.

As described in greater detail below, the system 300 of FIG. 3 may support a semantic network object model. The object model integrates many of the standard features of conventional object database management systems such as, for example, classes, multiple inheritance, methods, polymorphism, etc. The application schema may be language independent and may be stored in the database. The dynamic schema capability of the database system 300 of the present invention allows a user to add or remove classes or properties to or from one or more objects while the system is on-line. Moreover, the database management system of the present invention provides a number of additional advantages and features which are not provided by conventional object database management systems (ODBMSs) such as, for example, text-indexing, intrinsic versioning, ability to handle real-time feeds, ability to preserve recovery data without the use of traditional log files, etc. Further, the database system 300 automatically manages the integrity of relationships by maintaining bidirectional links between objects. Additionally, the data model of the present invention may be dynamically extended without interrupting production systems or recompiling applications.

According to a specific embodiment, the database system 300 of FIG. 3 may be used to efficiently manage BLOBs (such as, for example, multimedia data-types) stored within the database itself. In contrast, conventional ODBMS and RDBMS systems do not store BLOBs within the database itself, but rather resort to storing BLOBs in file systems external to the database. According to one implementation, the database system 300 may be configured to include a plurality of media APIs which provide a way to access data at any position through a media stream, thereby enabling an application to jump forward, backward, pause, and/or restart at any point of a media or binary stream.

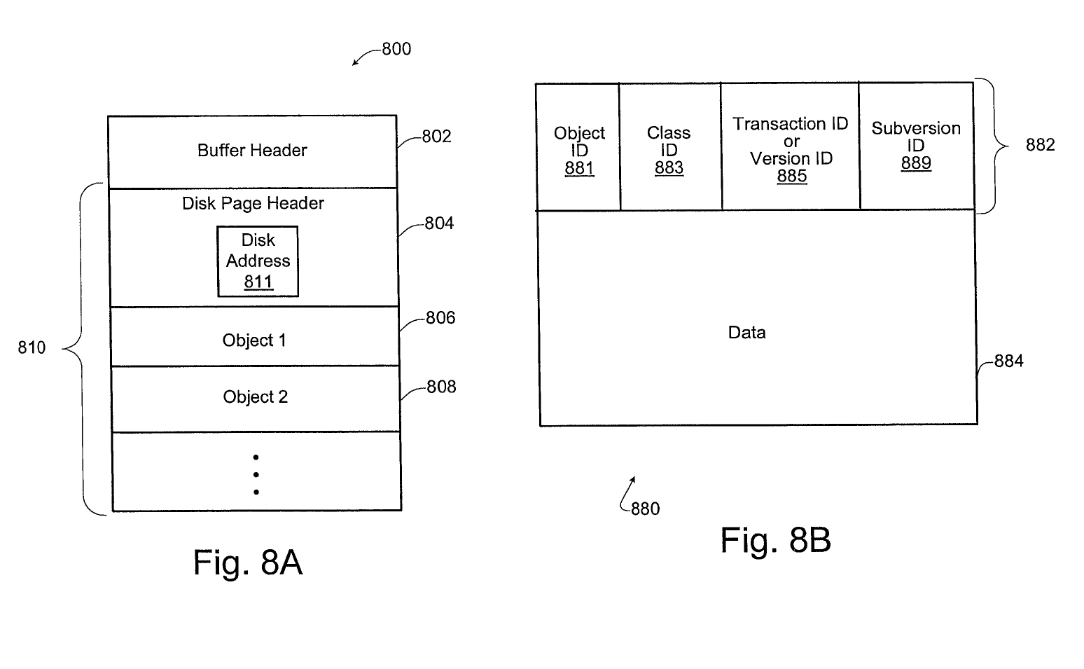

FIG. 8A shows a specific embodiment of a block diagram of a disk page buffer 800 which, for example, may correspond to the disk page buffer 311 of FIG. 3. As shown in FIG. 8A, the disk page buffer 800 includes a buffer header portion 802 and a disk page portion 810. The disk page portion 810 includes a disk page header portion 804, and may include copies of one or more different object versions (e.g. 806, 808). According to a specific embodiment, the disk page header portion 804 may include at least one field, such as, for example, a disk address field 811 for storing the address of the memory location where the corresponding disk page is stored in the persistent memory.

According to a specific implementation, the disk page buffer 800 may be configured to include one or more disk pages 810. In the embodiment of FIG. 8A, the disk page buffer 800 has been configured to include only one disk page 810, which, according to specific implementations, may have an associated byte size of 4K or 8K bytes, for example.

FIG. 8B shows a block diagram of a version of a database object 880 in accordance with a specific embodiment of the present invention. According to a specific implementation, each of the object versions 806, 808 of FIG. 8A may be configured in accordance with the object version format shown in FIG. 8B.

Thus, for example, as shown in FIG. 8B, object 880 includes a header portion 882 and a data portion 884. The data portion 884 of the object 880 maybe used for storing the actual data associated with that particular object version. The header portion includes a plurality of fields including, for example, an Object ID field 881, a Class ID field 883, a Transaction ID or Version ID field 885, a Sub-version ID field 889, etc. According to a specific implementation, the Object ID field 881 represents the logical ID associated with that particular object. Unlike conventional RDBMS systems which require that an Object be identified by its physical address, the information storage and retrieval system of the Parent Application allows objects to be identified and accessed using a logical identifier which need not correspond to the physical address of that object. In one embodiment, the Object ID may be configured as a 32-bit binary number.

The Class ID field 883 may be used to identify the particular class of the object. For example, a plurality of different object classes may be defined which include user-defined classes as well as internal structure classes (e.g., data pages, B-tree page, text page, transaction object, etc.).

The Version ID field 885 may be used to identify the particular version of the associated object. The Version ID field may also be used to identify whether the associated object version has been converted to a stable state. For example, according to a specific implementation, if the object version has not been converted to a stable state, field 885 will include a Transaction ID for that object version. In converting the object version to a stable state, the Transaction ID may be remapped to a Version ID, which is stored in the Version ID field 885.

Additionally, if desired, the object header 882 may also include a Subversion ID field 889. The subversion ID field may be used for identifying and/or accessing multiple copies of the same object version. According to a specific implementation, each of the fields 881, 883, 885, and 889 of FIG. 8B may be configured to have a length of 32 bits, for example.

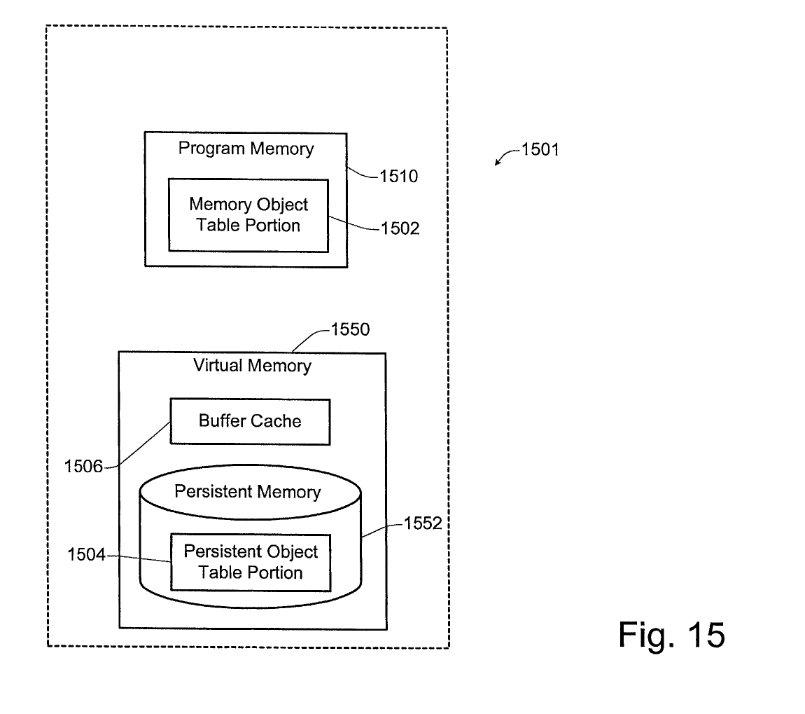

FIG. 15 shows a specific embodiment of a block diagram illustrating how different portions of the Object Table 1501 maybe stored within the information storage and retrieval system of the present invention. According to a specific implementation, Object Table 1501 may correspond to the Object Table 101 illustrated in FIG. 3. As explained in greater detail below, a first portion 1502 (herein referred to as the Memory Object Table or MOT) of the Object Table 1501 may be located within volatile memory 1510, and a second portion 1504 (herein referred to as the Persistent Object Table or POT) of the Object Table 1501 may be located in virtual memory 1550. According to at least one implementation, volatile memory 1510 may include volatile memory (e.g., RAM), and virtual memory 1550 may include a memory cache 1506 as well as persistent memory 1504. According to a specific embodiment, portions of the Persistent Object Table (POT) 1504 may be stored as disk pages in the persistent memory 1552 and the buffer cache 1550. According to a specific implementation, when updates are made to portions of the Persistent Object Table, the updated portions are first created as pages in the buffer cache and then flushed to the persistent memory.

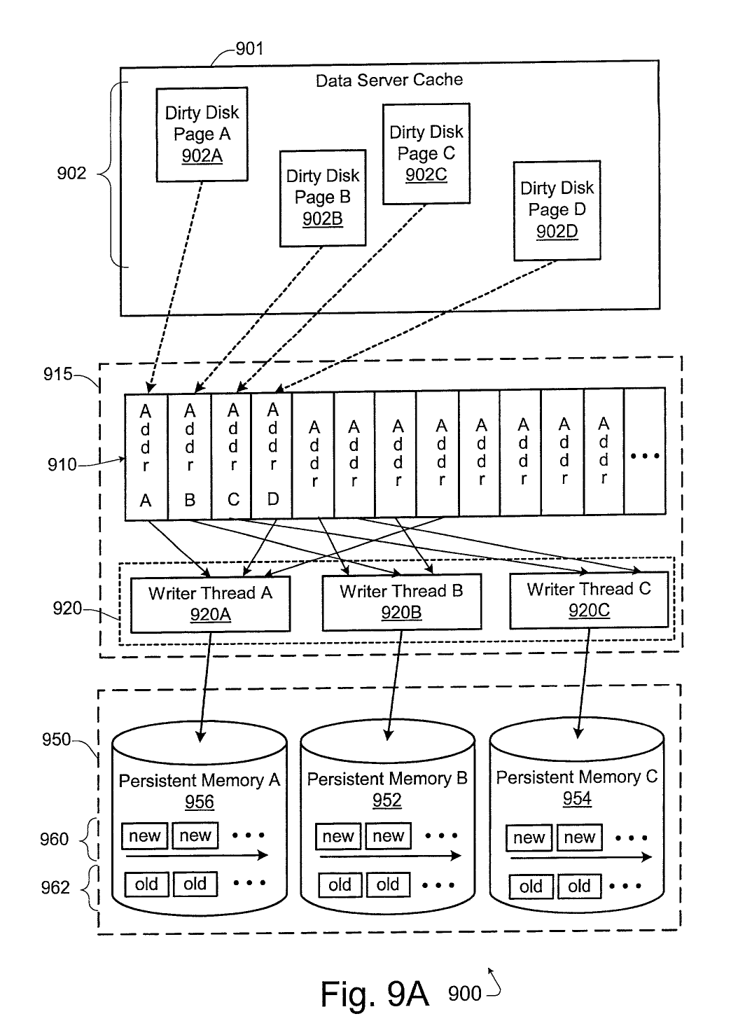

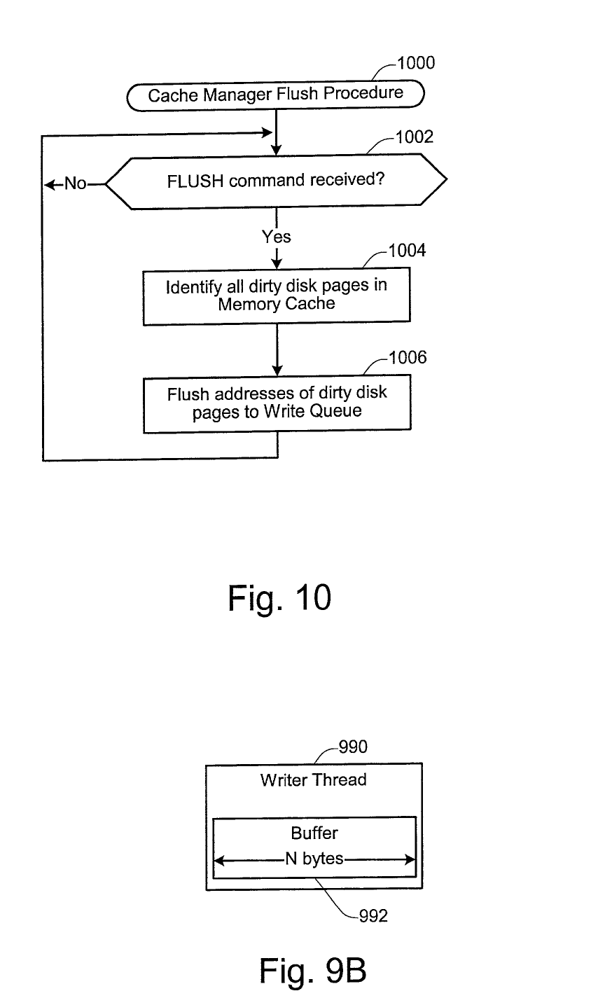

FIG. 9A shows a block diagram of a specific embodiment of a virtual memory system 900 which may be used to implement an optimized block write feature of the present invention. As shown in the embodiment of FIG. 9A, the virtual memory system 900 includes a data server cache 901, write optimization data structures 915, and persistent memory 950, which may include one or more disks or other persistent memory devices. In the embodiment of FIG. 9A, the write optimization data structures 915 include a Write Queue 910 and a plurality of writer threads 920. The functions of the various structures illustrated in FIG. 9A are described in greater detail with respect to FIGS. 10-12 of the drawings.

Generally, the addresses of dirty disk pages 902 (which are stored in the data server cache 901) are written into the Write Queue 910. According to a specific embodiment, a dirty disk page may be defined as a disk page in the data server cache which is inconsistent with the corresponding disk page stored in the persistent memory. The plurality of writer threads 920 continuously monitor the Write Queue for new dirty disk page addresses. According to a specific embodiment, the writer threads 920 continuously compete with each other to grab the next available dirty disk page address queued in the Write Queue 910. When a writer thread grabs or fetches an address from the Write Queue, the writer thread copies the dirty disk page corresponding to the fetched address into an internal write buffer. The writer thread is able to queue a plurality of dirty disk pages in its internal write buffer. According to a specific implementation, the maximum size of the write buffer may be set equal to the maximum allowable block size permitted for a single write request to a specific persistent memory device. When the write buffer becomes full, the writer thread may perform a single block write request to a selected persistent memory device of all dirty disk pages queued in the write buffer of that writer thread. In this way, optimized block writing of data to one or more persistent memory devices may be achieved.

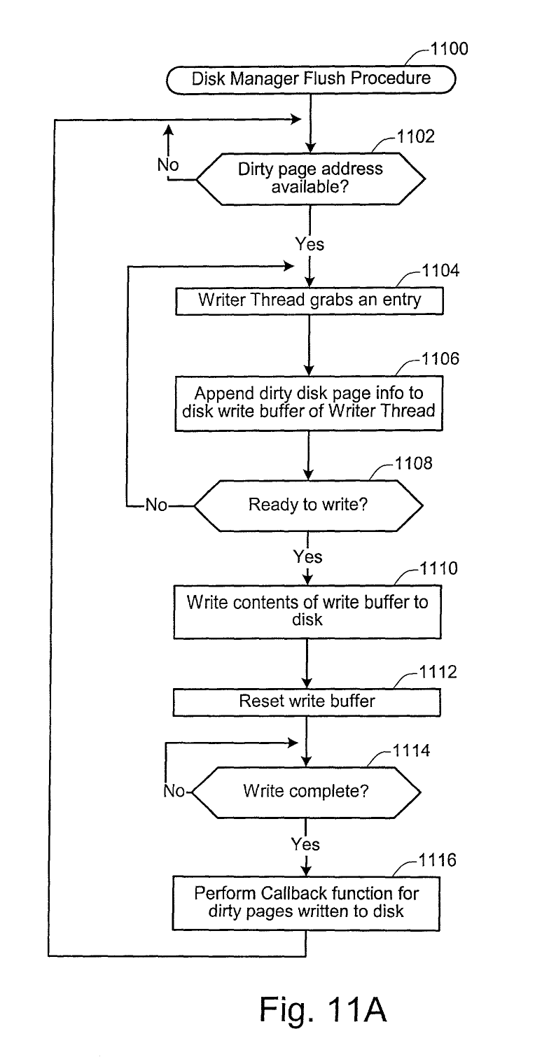

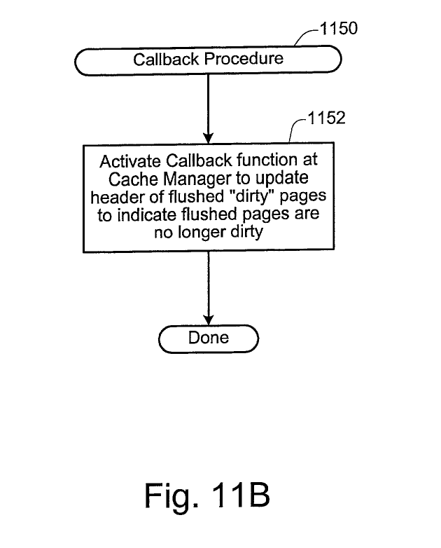

FIG. 10 shows a flow diagram of a Cache Manager Flush Procedure 1000 in accordance with a specific embodiment of the present invention. According to a specific implementation, the Cache Management Flush Procedure 1000 may be configured as a process in the database server which runs asynchronously from other processes such as, for example, the Disk Manager Flush Procedure 1100 of FIGURE 11A.

Initially, as shown at 1002 of FIG. 10, the Cache Manager Flush Procedure waits to receive a FLUSH command. According to a specific implementation, the FLUSH command may be sent by the Transaction Manager. Once the Cache Manager

Flush Procedure has received a FLUSH command, it identifies (1004) all dirty disk pages in the data server cache. According to one implementation, a dirty disk page may be defined as a disk page which includes at least one new object that is inconsistent with the corresponding disk page data stored in the persistent memory. It is noted that a dirty disk page may include multiple object versions. In one implementation, the Transaction Manager may be responsible for keeping track of the dirty disk pages stored in the data server cache. After the dirty disk pages have been identified, the addresses of the identified dirty disk pages are then flushed (1006) to the Write Queue 910. Thereafter, the Cache Manager Flush Procedure waits to receive another FLUSH command.

FIG. 11A shows a flow diagram of a Disk Manager Flush Procedure 1100 in accordance with a specific embodiment of the present invention. According to one embodiment, a separate thread or process of the Disk Manager Flush Procedure may be implemented at each respective writer thread (e.g. 920A, 920B, 920C, etc.) running on the database server. Further, according to at least one embodiment, each writer thread may be configured to write to a designated disk or persistent memory device of the persistent memory. For purposes of illustration, it will be assumed that the Disk Manager Flush Procedure 1100 is being implemented at the Writer Thread A 920A of FIG. 9A.

As shown at 1102 of FIG. 11 A, the Writer Thread A continuously monitors the Write Queue 910 for an available dirty page address. As illustrated in the embodiment of FIG. 9A, each of the writer threads 920A-C compete with each other to grab dirty disk page addresses from the Write Queue as they become available. According to a specific embodiment, the Write Queue may be configured as a FIFO buffer.

When the writer thread detects an available entry in the Write Queue 910, the writer thread grabs (1104) the entry and identifies the dirty disk page address associated with that entry. Once the address of the dirty disk page has been identified, the writer thread copies desired information from the identified dirty disk page (stored in the data server cache 901), and appends (1106) the dirty disk page information to a disk write buffer of the writer thread. An example of a disk write buffer is illustrated in FIG. 9B of the drawings.

FIG. 9B shows a block diagram of a writer thread 990 in accordance with a specific embodiment of the present invention. As illustrated in FIG. 9B, the writer thread 990 includes a disk write buffer 992 for storing dirty disk page information that is to be written to the persistent memory. According to a specific implementation, the size (N) of the writer thread buffer 992 may be configured to be equal to the maximum allowable byte size of a block write operation to a specified disk or other persistent memory device. Referring to FIG. 9A, for example, if the maximum block write size for a write operation of disk 956 is 128 kilobytes, then the size of the writer thread buffer 992 may be configured to be 128 kilobytes. Thereafter, when the writer thread buffer 992 becomes filled with dirty page data, it may write the entire contents of the buffer 992 to persistent memory A device 956 during a single block write operation. In this way, optimization of block disk write operations may be achieved.

Returning to FIG. 11A, after the writer thread has appended the dirty disk page information to its disk write buffer, a determination is then made (1108) as to whether the writer thread is ready to write the data from its buffer to the persistent memory (e.g. persistent memory A 956). According to a specific implementation, writer thread may be ready to write its buffered data to the persistent memory in response to determining either that (1) the writer thread buffer has become full or has reached the maximum allowable block write size, or (2) that the Write Queue 910 is empty or that no more dirty disk page addresses are available to be grabbed. If it is determined that the writer thread is not ready to write its buffered data to the persistent memory, then the writer thread grabs another entry from the Write Queue and appends the dirty disk page information to its disk write buffer.

When the writer thread determines that it is ready to write its buffered dirty page information to the persistent memory, it performs a block write operation by writing the contents of its disk write buffer 992 to the designated persistent memory device (e.g. persistent memory A 956). According to a specific implementation, block writes of dirty disk pages may be written to the disk in a consecutive and sequential manner in order to minimize disk head movement. This feature is discussed in greater detail below. Additionally, as described above, the writing of the contents of the disk write buffer to the disk may be performed during a single disk block write operation.

According to a specific implementation, after the contents of the writer thread buffer have been written to the disk, the disk write buffer may be reset (1112), if desired. At 1114 a determination may then be made as to whether the block write operation has been completed. According to a specific embodiment, the Disk Manager may be configured to make this determination. Once it is determined that the disk block write operation has been completed, a Callback Procedure may be implemented (1116) in order to update the header information of the flushed “dirty” disk page(s) to indicate that the flushed page(s) are no longer dirty. An example of a Callback Procedure is illustrated in FIG. 11 B of the drawings.

It will be appreciated that the information storage and retrieval system of the Parent Application provides a number of advantages which may be used for optimizing and enhancing storage and retrieval of information to and from a database system. For example, unlike conventional RDBMS systems, new versions of objects may be stored at any desired location in the persistent memory, whereas conventional techniques require that updated information relating to a particular object be stored at a specific location in the persistent memory allocated to that particular object. Accordingly, the information storage and retrieval system of the Parent Application allows for significantly improved disk access performance. For example, in conventional database systems, the disk head must be continuously repositioned each time information relating to a particular object is to be updated. However, using the optimized block write technique of the present invention as described in the Parent Application, updated object data may continuously be written in a sequential manner to the disk. This feature significantly improves disk access speed since the disk head does not need to be repositioned with each new portion of updated object data that is to be written to the disk. Thus, not only does the optimized block write technique of the present invention provide for optimized disk write performance, but the speed at which the write operations may be performed may also be significantly improved since the disk block write operations may be performed in a sequential manner.

FIG. 11B shows a flow diagram of a Callback Procedure 1150 in accordance with a specific embodiment of the present invention. According to one implementation, the Callback Procedure 1150 may be implemented or initiated by the Disk Manager. As shown at 1152 the callback procedure or function may be configured to cause the Cache Manager to update the header information in each of the flushed dirty disk pages to indicate that the flushed disk pages are no longer dirty. According to a specific embodiment, the header of a flushed disk page residing in the data server cache may be updated with the new disk address of the location in the persistent memory where the corresponding disk page was stored.

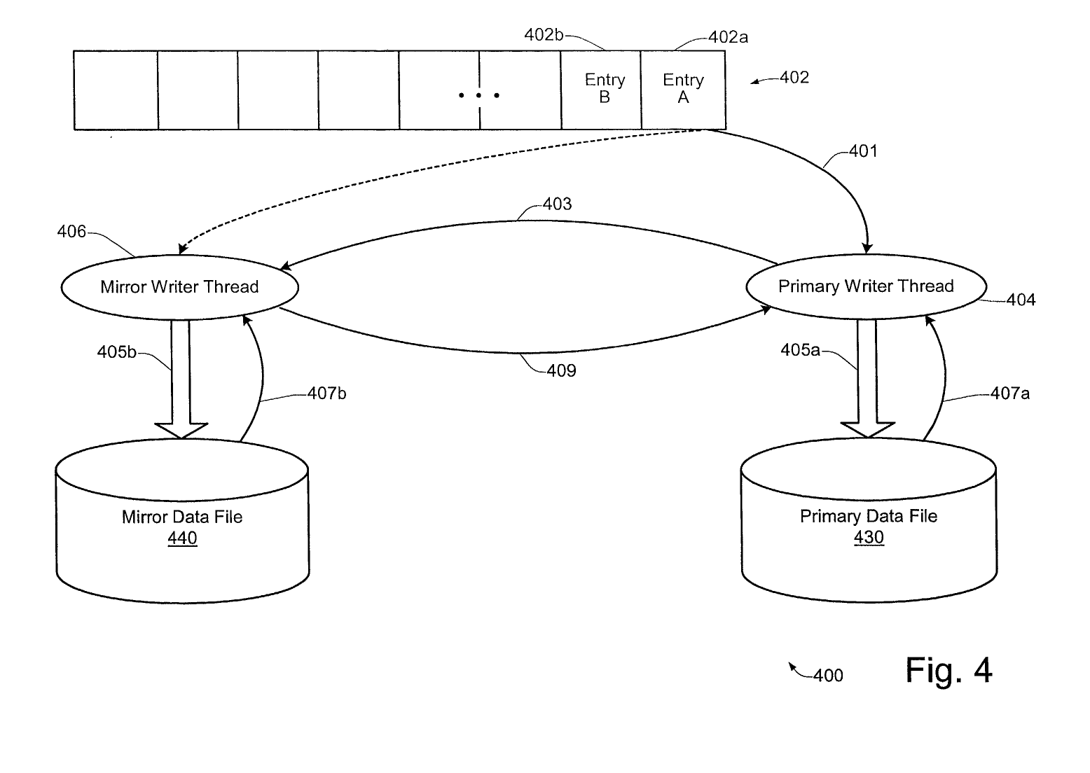

FIG. 4 shows a specific embodiment of a flow diagram illustrating the interaction between different components of an information storage and retrieval system 400 during implementation of a specific embodiment of the system modification processing technique of the present invention. In the embodiment of FIG. 4, it is assumed that the information storage and retrieval system 400 corresponds to a specific embodiment of an information storage and retrieval system implemented in accordance with the technique described in the Parent Application. The various system components shown in FIG. 4 include, for example, a write queue 402, a primary writer thread 404, a mirror writer thread 406, a primary data file 430, and a mirror data file 440. According to a specific implementation, a data file may be implemented as one or more disk drives in the persistent memory. For example, according to one embodiment, the information storage and retrieval system of the present invention may include a plurality of primary writer threads. In one implementation, a separate primary writer thread may be instantiated for each primary data file in the persistent memory. Additionally, a separate mirror writer thread may be instantiated for each mirror data file in the persistent memory.

The write queue 402 includes a plurality of entries (e.g. 402A, 402B, etc.), typically corresponding to requests for accessing data stored in the persistent memory. According to a specific embodiment, the different types of requests which may be queued in the write queue 402 may include, for example, standard data access requests (e.g. write requests, read requests, etc.), specialized system requests such as, for example, create mirror data file, remove mirror data file, remove primary data file, etc., each of which is described in greater detail below. A more detailed description of the various aspects relating to the write queue 402 is provided with respect to FIG. 9A of the drawings. For purposes of illustration, it is assumed that Entry A 402a of write queue 402 corresponds to a write request for writing specific data to the persistent memory.

At 401 the primary writer thread 404 reads the request associated with Entry A from the write queue 402. In the present example, it is assumed that the request associated with Entry A corresponds to a write request. The primary writer thread then sends (403) a wake up signal to the mirror writer thread 406. The mirror then wakes up and sees the write request corresponding to Entry A.

The mirror writer thread and primary writer thread each write (405b, 405a) the data from Entry A to their respective data files 430, 440. According to a specific embodiment, a synchronous write operation may be performed in order to allow the data to be written to the mirror data file 440 and primary data file 430 at substantially the same time.

After the appropriate data has been written to the primary data file 430 and mirror data file 440, write completion event notification is generated at each of the data files and sent to its respect writer thread. Thus, for example, as shown in FIG. 4, a first write completion signal is generated at primary data file 430 and transmitted 407a to primary writer thread 404. Additionally, a second write completion signal is generated at mirror data file 440 and transmitted 407b to mirror writer thread 406. The mirror writer thread then notifies (409) the primary writer thread of the mirror data file's write completion event.

Once the primary writer thread has verified that it has received a write completion acknowledgement from both the primary data file and the mirror writer thread, the primary writer thread then grabs the next entry (e.g. Entry B 402b) in the write queue for processing.

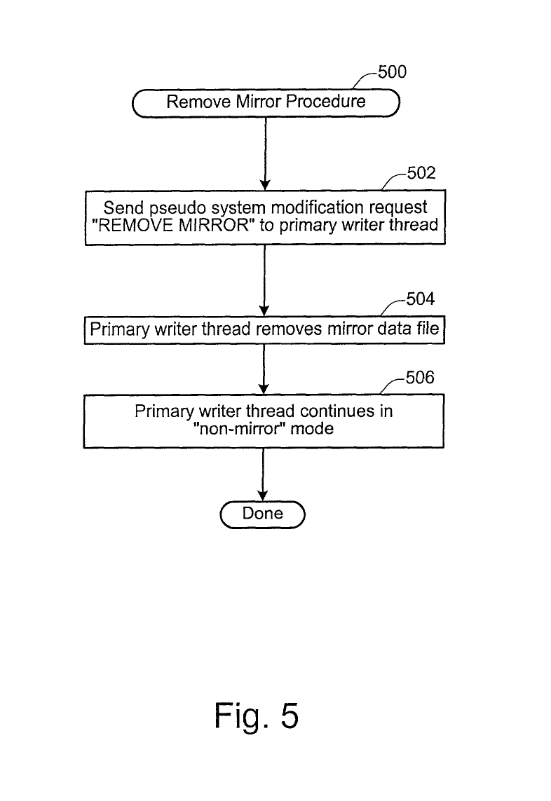

According to different embodiments of the present invention, at least a portion of the entries within the write queue 402 may correspond to system modification requests for modifying a portion of the information storage and retrieval system. According to one implementation, a system modification request may be implemented in the form of a pseudo access request, such as, for example, a pseudo write request. Examples of various types of system modification requests are illustrated in FIGS. 5, 6, 7, and 12 of the drawings, and include, for example, a Remove Mirror request, a Remove Primary request, an Add Mirror request, a Remove Non-Mirrored Data File request, etc. According to a specific implementation, primary writer threads may be used for implementing system and/or administrative operations including, for example, system modification operations corresponding to the various system modification requests described herein.

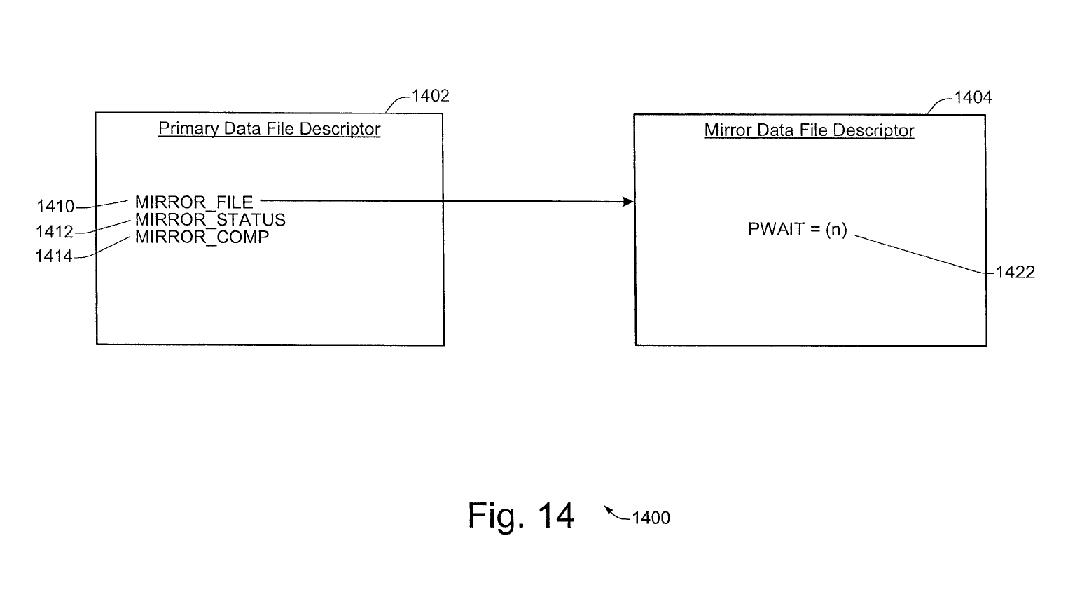

According to a specific embodiment, when the status of a primary data file or a mirror data file has been changed or modified, information stored within appropriate writer thread data structures may also be modified to reflect the changes. FIG. 14 shows a block diagram illustrating an example of various writer thread data structures 1400 in according with a specific embodiment of the present invention. As shown in FIG. 14, the writer thread data structures may include a primary data file descriptor 1402 and a mirror data file descriptor 1404. In one implementation, a separate instance of a primary data file descriptor may be established for each respective primary writer thread in the system. Additionally, a separate instance of a mirror data file descriptor may be created for each respective mirror writer thread in the system.

As shown in the embodiment of FIG. 14, the primary data file descriptor 1402 may include, for example, a MIRROR_FILE field 1410, a MIRROR_STATUS field 1412, a MIRROR_COMP field 1414, etc. In one implementation, the MIRROR_FILE field 1410 may include a pointer or other information relating to the location or identity of an associated mirror data file descriptor. The MIRROR_STATUS field 1412 may be used to describe the current status of the associated mirror data file (e.g. active, inactive, etc.). The MIRROR_COMP field 1414 may be used to store information relating to one or more event completion notifications (e.g. write completion event notification) received from the associated mirror data file or mirror writer thread.

As shown in the embodiment of FIG. 14, the mirror data file descriptor 1404 may also include at least one field including, for example, a PWAIT field 1422 which may be used by the mirror writer thread, for example, to determine whether to immediately proceed with a specified task, or to wait until action and/or notification is received from the primary writer thread before implementing specific action. For example, in a specific implementation, the value n=(−1) may be used to indicate that the mirror writer thread is to wait for notification from the primary writer thread before taking specific action, whereas a value of n=1 may be interpreted by the mirror writer thread to mean that the mirror writer thread does not need to wait for a signal from the primary writer thread before proceeding with one or more actions.

FIG. 5 shows a flow diagram of a Remove Mirror Procedure 500 in accordance with a specific embodiment of the present invention. In a specific implementation, the Remove Mirror Procedure 500 may be initiated in order to remove or make inactive a selected mirror data file of the persistent memory.

As shown in the embodiment of FIG. 5, the Remove Mirror Procedure may be initiated by and queuing in the write queue 402 a “Remove Mirror” system modification request. In one implementation, all system modification requests and/or pseudo access requests are assigned a relatively high priority in order to allow such requests to be immediately queued at the head of the write queue.

As shown at 502 of FIG. 5, a “Remove Mirror” system modification request is sent to the primary writer thread via the write queue. According to one implementation, the identity of the mirror data file to be removed may be specified in the system modification request. Alternatively, the identity of the appropriate mirror data file may be determined based upon the identity of the primary writer thread which has been identified as the intended recipient of the Remove Mirror request. Once the primary writer thread has received the Remove Mirror request, it removes (504) the appropriate mirror data file from use in the persistent memory. In one embodiment, the removal of the mirror data file may be accomplished by taking in the mirror data file off-line, or changing of the status of the mirror data file to “inactive”.

Once the primary writer thread has taken the appropriate actions to remove or make inactive the selected mirror data file, the primary writer thread then continues operating (506) in a “non-mirror” mode. According to a specific implementation, the “non-mirror” mode may omit specific operations relating to communication with the mirror writer thread such as, for example, the wake up signal 403, and write completion notification 409 described previously with respect to FIG. 4.

According to a specific embodiment, the primary writer thread may call one or more system procedures in order to perform the appropriate tasks associated with the various system modification requests. For example, as described at 504 of FIG. 5, the primary writer thread may take appropriate action to remove the mirror data file in order to allow the primary data file to continue functioning in a non-mirrored environment. During the removal of the mirror data file, internal descriptors which link the mirror data file with the primary data file may be deleted or modified. For example, the MIRROR_FILE field 1410 within the primary data file descriptor may be set to NULL.

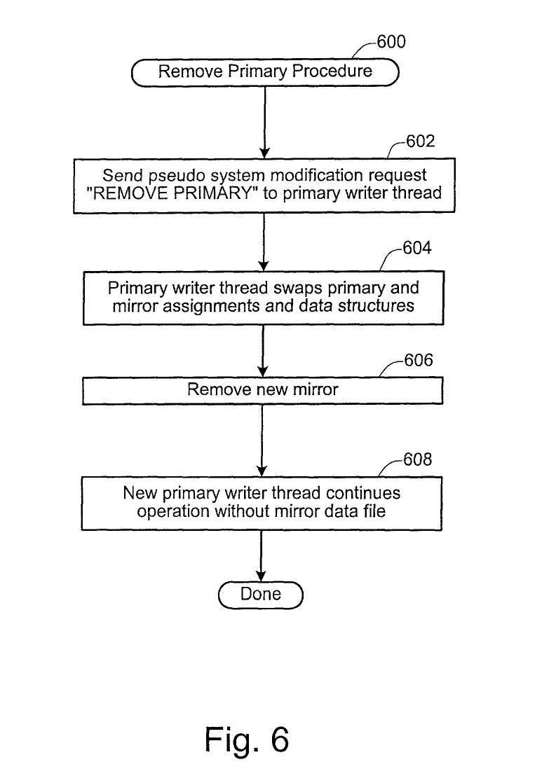

FIG. 6 shows a flow diagram of a Remove Primary Procedure 600 in accordance with a specific embodiment of the present invention. According to a specific implementation, the Remove Primary Procedure may be evoked by a system modification request to cause a mirror data file (associated with a primary data file) to be reassigned as the new primary data file, and to remove the old primary data file from use in the persistent memory.

At 602, a “Remove Primary” system modification request is sent to the primary writer thread. In a specific implementation, the “Remove Primary” request is sent via write queue 402. When the primary writer thread receives the Remove Primary request, its swaps (604) the primary and mirror assignments and other associated data structure information. After the swap operation has been successfully completed, the old mirror data file will preferably be assigned as the new primary data file, and the old primary data file will preferably be assigned as the new mirror data file. Thus, for example, referring to FIG. 4, the old primary data file 430 will be assigned as the new mirror data file, and the old mirror data file 440 will be assigned as the new primary data file. This may be accomplished, for example, by remapping the pointer information stored in the primary and mirror data file descriptors. Additionally, the information contained within the primary data file descriptor 1402 and mirror data file descriptor 404 may be updated to reflect the new assignment information.

Once the swapping of the primary and mirror data file assignments has been completed, the newly assigned mirror data file may be removed (606) or taken off-line. Thereafter, the new primary writer thread may continue to operate (608) in a non-mirror mode.

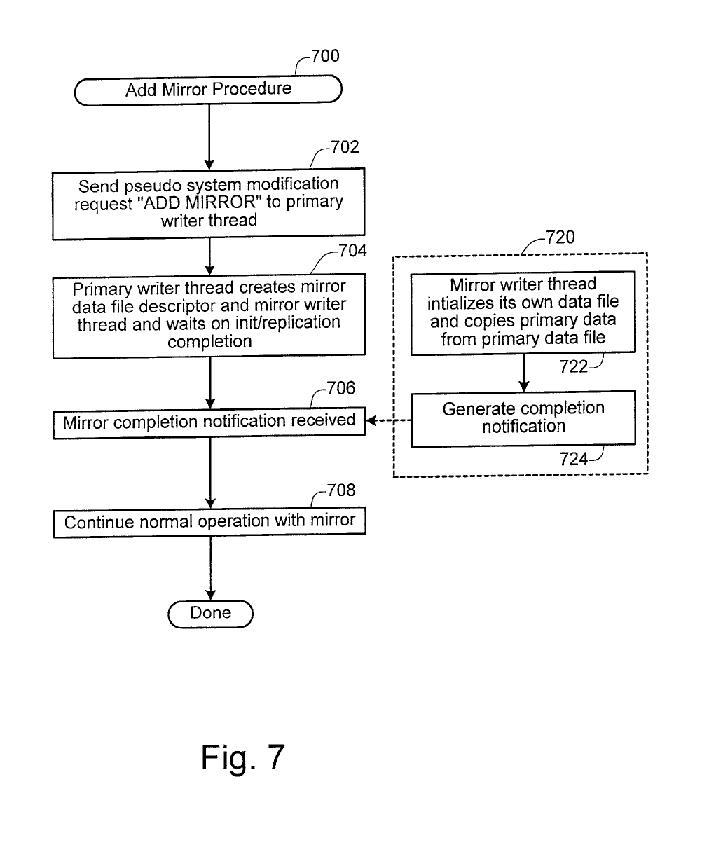

FIG. 7 shows a flow diagram of an Add Mirror Procedure 700 in accordance with a specific embodiment of the present invention. The Add Mirror Procedure may be used, for example, to add a mirror data file for a selected primary data file. It will be appreciated that, when adding a mirror data file in a conventional relational database system, such systems typically require down time for the primary data file to be taken off-line while the data stored in the primary data file is copied to the mirror data file. One reason for this requirement is that conventional relational databases typically require positional updates, meaning that an update to a particular object in the relational database can only be stored in a specific memory location which has been previously allocated for that object. Thus, in order to ensure that the data copied from the primary data file to the mirror data file is exactly the same, write access to the primary data file is typically blocked in conventional relational database systems in order to prevent data updates or other modifications of data which may affect the consistency of data between the primary data file and mirror data file.

However, as explained in greater detail below, the non-positional data update technique of the present invention may be used to allow a mirror data file to be added to the information storage and retrieval system of the present invention without taking the system off-line or blocking write access to at least a portion of the objects stored within the database.

Initially, as shown at 702, an “Add Mirror” system modification request is sent to the primary writer thread. According to a specific implementation the Add Mirror request may be sent via the write queue 402. The primary writer thread responds by creating (704) a mirror data file descriptor and mirror writer thread, and then waits for notification from the mirror writer thread of a mirror completion event.

Once the mirror writer thread has been initialized, it may perform a series of operations (e.g. 720) relating to the creation of the mirror data file. For example, the mirror writer thread may initialize a mirror data file and commence copying of the data from the primary data file to the mirror data file (722). When the mirror writer thread has determined that the mirror data file has been successfully created, it generates (724) a mirror completion event notification signal, which is then sent to the primary writer thread.

At 706 the primary writer thread receives the mirror completion event notification signal from the mirror writer thread. Thereafter, the primary writer thread continues to operate (708) in a “mirror” mode such as that described, for example, in FIG. 4 of the drawings.

According to a specific embodiment, during execution of the Add Mirror Procedure 700, write access to the primary data file (whose data is used for creating the mirror data file) is disabled while the data from the primary data file is being copied to the mirror data file. However, according to at least one implementation, updates to objects stored in the database (including objects which are stored on the primary data file) will not be disabled or prohibited during the Add Mirror procedure. One reason why updates to objects stored in the database are not blocked during the Add Mirror procedure is because the information storage and retrieval system of the present invention allows for non-positional updates of object data stored within the database.

For example, as described previously with respect to FIG. 9A, the multiple writer thread embodiment of the present invention combined with the non-positional update feature of the present invention provides the ability for the information storage and retrieval system of the present invention to allow continuous data updates even at times when portions of the persistent memory are off-line or inaccessible. Thus, even during times when the primary data file and/or mirror data file are unavailable for write access, the non-positional object update technique of the present invention allows other writer threads to write object updates to any other available disk in the persistent memory.

Accordingly, it will be appreciated that one advantage of the information storage and retrieval system of the present invention is that there is no down time required when adding or creating a mirror data file. Thus, unlike conventional relational database techniques, a mirror data file may be added or created in the database of the present invention without the need to close table spaces in the persistent memory, and without the need to block data updates to objects stored in the persistent memory.

Additionally, it will be appreciated that read access to the primary data file may still be available during the Add Mirror procedure, even during times when data from the primary data file is being copied to the mirror data file.

According to different embodiments, implementation of mirror data files for selected primary data files may be performed either manually, or automatically based upon predetermined criteria. For example, mirror data files for selected primary data files may automatically be implemented based upon program logic, automated scripting, predetermined business rules, administrative considerations, etc. This provides a large degree of flexibility of administration over the information storage and retrieval system.

On occasion, situations may arise where it is necessary to remove a non-mirrored (or non-replicated) primary data file from the persistent memory. For example, it may be desirable to replace or upgrade a disk drive in the persistent memory (which has been configured as a primary data file), or it may be desirable to reformat the disk drive. In such situations, the disk drive or data file may need to be removed from use in the persistent memory and/or taken off-line while the necessary repairs or modifications are being made.

In conventional RDBMS systems, there are a number of different techniques which may be used for maintaining data integrity when removing a non-replicated disk or data file from the database. For example, a new mirror data file may be created to mirror the data on the primary data file which is to be removed. However, as described previously, access to data stored on the primary data file will be temporarily unavailable during creation of the mirror data file. Once the mirror data file has been successfully created access to the data stored on the duplicate or mirror data file may then be enabled. Thereafter, the primary data file may be removed from the database without further service interruption, and the mirror data file may take over as the new primary data file.

Another approach which may be used for dealing with the removal of a non-replicated data file is to redistribute the data from the non-replicated data file to other data files in the persistent memory. However, according to conventional techniques, in order to redistribute the data stored on a particular data file, down time must be scheduled wherein all data files (e.g. disks) are taken off-line. The table spaces stored on the data file to be removed are then manually re-created in other data files. Data from the selected data file (e.g. the data file which is to be removed) is then copied into the appropriate new table spaces created in the other data file locations. During this entire procedure, access to data stored within the affected portions of the database will be disabled until all of the data from the selected data file has been redistributed. This may result in several hours of service disruption for a relatively large data sets (e.g. greater than 1 gigabyte of data).

However, as described in greater detail below, the technique of the present invention provides a mechanism whereby a non-mirror data file may be removed from use in the persistent memory without restricting or disabling read/write access to information stored in the non-mirrored data file, or other portions of the persistent memory.

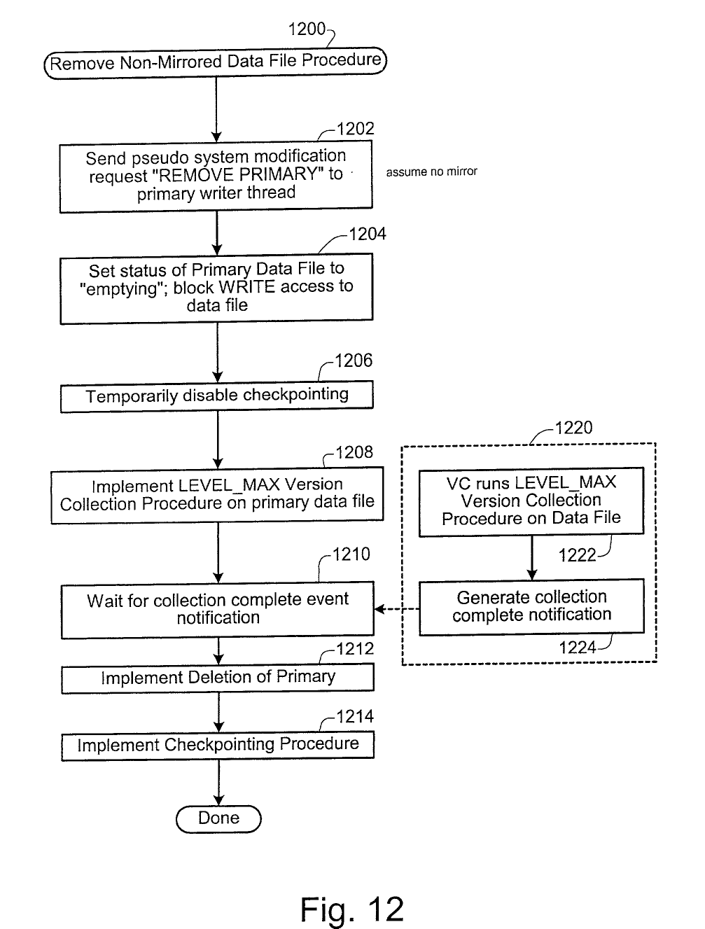

FIG. 12 shows a flow diagram of a Remove Non-Mirrored Data File procedure 1200 in accordance with a specific embodiment of the present invention. According to one embodiment, the Remove Non-Mirrored Data File procedure 1200 may be implemented in an information storage and retrieval system described, for example, in FIG. 3 of the drawings in order to remove a non-mirrored data file or disk from use as storage device in the persistent memory.

Initially, as shown at 1202 of FIG. 12, a “Remove Primary” system modification request is sent to a primary writer thread associated with a selected data file which is to be removed (herein referred to as the “selected primary data file”). In one implementation, the Remove Primary request may be sent to the primary writer thread via the write queue as a pseudo write request. In the embodiment of FIG. 12, it is assumed that the data file to be removed corresponds to a primary data file which has no mirror data file associated therewith.

When the primary writer thread receives the Remove Primary request, it then sets (1204) the current status of the selected primary data file to “emptying” status, and further blocks all write access requests to the selected primary data file. According to a specific embodiment, read requests may still be permitted until the selected primary data file has been removed. Additionally, according to a specific embodiment, all check pointing operations for the selected primary data file may temporarily be disabled (1206).

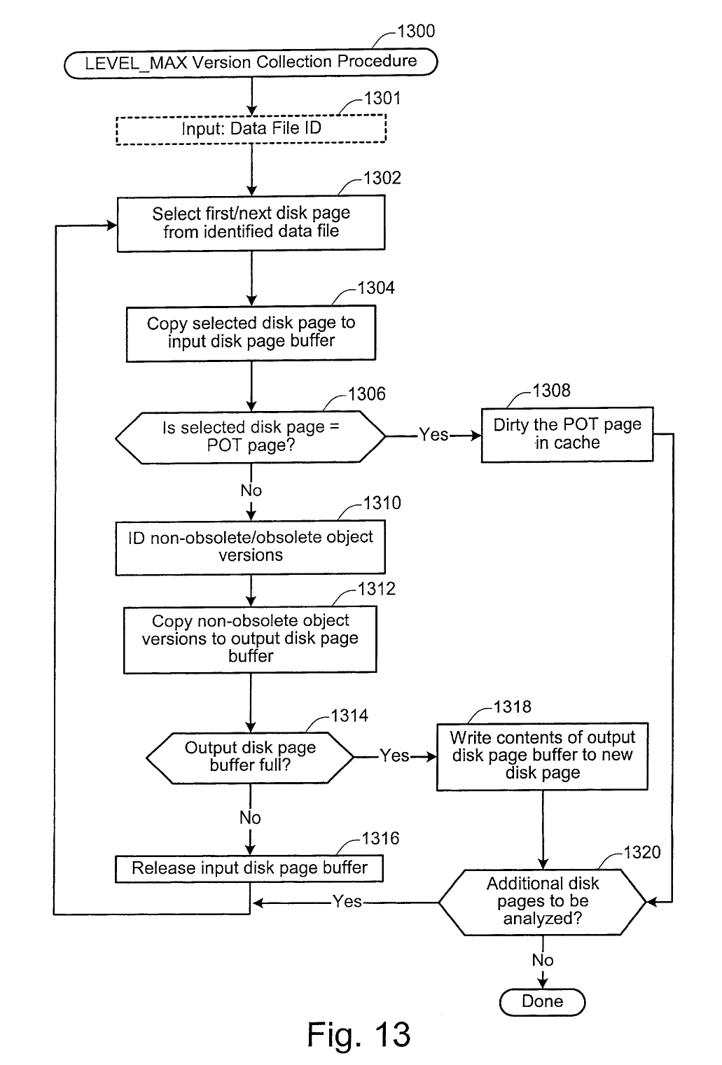

At 1208 a LEVEL_MAX version collection procedure is implemented on the selected primary data file. An example of a LEVEL_MAX version collection procedure is illustrated and described in greater detail in FIG. 13 of the drawings.

According to a specific embodiment, a version collector manager may be responsible for executing (1222) the LEVEL_MAX version collection procedure on the selected primary data file. During execution of the LEVEL_MAX version collection procedure, disk pages from the specified data file (e.g. the selected primary data file) are analyzed for version collection. Non-obsolete object versions identified from the disk pages are then written to new disk pages on other data files (e.g. disks) which are configured to allow write access. Obsolete object versions stored on the selected primary data file which are identified during the LEVEL_MAX version collection procedure may be discarded. At the completion of the LEVEL_MAX version collection procedure, all non-obsolete data from the selected primary data file should preferably be copied and distributed to other active data files in the persistent memory. Accordingly, upon successful completion of the LEVEL_MAX version collection procedure, a collection complete event notification signal is generated (1224) and transmitted to the primary writer thread. Upon receiving (1210) notification of the collection complete event, the primary writer thread may then implement (1212) a self destruction procedure, wherein the primary writer thread and its associated primary data file descriptor are deleted and/or destroyed. Thereafter, a checkpointing procedure may be implemented (1214) in order to checkpoint the data currently stored in the database.

In one embodiment, concurrent read access operations from data stored on the selected primary data file will be available until destruction of the primary writer thread has been accomplished. According to a specific embodiment, since valid copies of all non-obsolete object versions from the selected primary data file have been distributed and stored on other data files, read access to any desired non-obsolete object version will preferably be available at all times before, during, and after execution of the Remove Non-Mirrored Data File procedure, under normal conditions. Additionally, as noted previously, the information storage and retrieval system of the present invention is configured to provide continuous write and/or update access to any desired object version stored in the database. Thus, for example, according to a specific embodiment, no restrictions are placed on data updates to desired object versions stored within the database, even during execution of the Remove Non-Mirrored Data File procedure.

FIG. 13 shows a flow diagram of a LEVEL_MAX Version Collection procedure 1300 in accordance with a specific embodiment of the present invention. According to a specific embodiment, the LEVEL_MAX Version Collection procedure 1300 represents a specific embodiment of a version collection procedure such as that, described, for example, in FIG. 20A of the Parent Application. In one implementation, the LEVEL_MAX Version Collection procedure may be used to distribute object data which is stored on a selected data file to other data files in the persistent memory in order to prepare the selected data file to be taken off-line.

Initially, as shown at 1301, the LEVEL_MAX Version Collection procedure receives at least one input parameter which includes information identifying a selected data file for analysis. A first disk page is then selected (1302) from the identified data file for analysis. The selected disk page is then copied (1304) to an input disk page buffer. A specific embodiment of an input disk page buffer is described, for example, in FIG. 19 of the Parent Application.

At 1306 a determination is made as to whether the selected disk page corresponds to a persistent object table (POT) page. If it is determined that the selected disk page does correspond to a POT page, then the status of the corresponding POT page in the memory cache is set to “dirty” (1308) in order to ensure that the dirty disk page (e.g. POT page) in the memory cache will be flushed to the persistent memory, for example, during execution of a cache manager flush procedure such as that described in FIG. 10 of the drawings.

According to a specific embodiment, one or more specific operations may be performed in order to cause the status of a disk page in the memory cache to be set to “dirty” status. For example, the physical address in the disk page header of the disk page in the memory cache may be reset. Additionally, a dirty disk page flag or bit field in the buffer head of the memory cache may also be set. According to a specific implementation, once the status of the disk page in the memory cache has been set to “dirty”, a request may then be sent to free the corresponding disk page in the persistent memory.

If, at 1306, it is determined that the selected disk page does not correspond to a POT page, then it may be assumed that the selected disk page includes one or more object versions. Accordingly, at 1310, non-obsolete object versions, and obsolete object versions stored on the selected disk page are identified. The non-obsolete object versions which are identified are then copied (1312) to an output disk page buffer such as the described, for example, in FIG. 19 of the Parent Application.

At 1314 a determination is made as to whether the output disk page buffer is full. Assuming that the output disk page buffer is not full, then additional non-obsolete object versions may be stored in the output disk page buffer before the contents of the output disk page buffer are written to the persistent memory. Accordingly, at 1316 the contents of the input disk page buffer are released, and a next disk page from the identified data file is selected (1302) for LEVEL_MAX Version Collection analysis.

Once it is determined that the output disk page buffer is full, the contents of the output disk page buffer may then be written (1318) to a new disk page of a data file (e.g. disk) in the persistent memory. According to a specific embodiment, the process of writing the new disk page to the persistent memory is described, for example, in with respect to FIGS. 19 and 20A of the parent application.

According to a specific embodiment, a write queue (e.g. 910, FIG. 9A) may be used to distribute data retrieved from an identified data file to other data files in the database. For example, according to one implementation, the contents of the output disk page buffer may be treated as a dirty disk page for purposes of flushing the contents of the output disk page buffer to an available data file in the persistent memory as illustrated, for example, in FIG. 9A. Additionally, it will be appreciated that updated object version data may also be stored in the data server cache in the form of one or more dirty disk pages, which may then be flushed to available data files in the persistent memory as shown, for example, in FIG. 9A. In this way, read and write access to information stored within the database may be continuously enabled even at times when one or more of the data files are taken off-line in order to perform administrative tasks or system modifications (e.g. addition of a mirror data file, removal of a non-mirrored data file, etc.).

At 1320 a determination is made as to whether there are additional disk pages in the identified data file to be analyzed for LEVEL_MAX Version Collection. If so, a next disk page is selected (1302) from the identified data file for analysis.

It will be appreciated that the technique of the present invention provides a number of advantages over conventional information storage and retrieval systems. As stated previously, one advantage of the present invention is that the addition and/or removal of a mirror data file and/or a primary data file may be implemented without requiring system down time during execution of such operations. Additionally, the creation and/or removal of a mirror data files or primary data files may be performed without blocking write access or data updates to data stored within the database. In this way, the information storage and retrieval system of the present invention is able to implement real-time processing of administrative operations and/or system of modification operations while simultaneously providing read/write access to data stored within the database.

Other Embodiments

Generally, the information storage and retrieval techniques of the present invention may be implemented on software and/or hardware. For example, they can be implemented in an operating system kernel, in a separate user process, in a library package bound into network applications, on a specially constructed machine, or on a network interface card. In a specific embodiment of this invention, the technique of the present invention is implemented in software such as an operating system or in an application running on an operating system.

A software or software/hardware hybrid implementation of the information storage and retrieval technique of this invention may be implemented on a general-purpose programmable machine selectively activated or reconfigured by a computer program stored in memory. Such programmable machine may be a network device designed to handle network traffic. The network device may be configured to include multiple network interfaces including frame relay, ATM, TCP, ISDN, etc. Specific examples of such network devices include routers, switches, servers, etc. In such network configurations, it will be appreciated that the system modification processing technique afforded by the present invention, and the more efficient data management that results, also significantly reduces or eliminates system delays associated with network latency and increased network traffic.

A general architecture for some of these machines will appear from the description given below. In an alternative embodiment, the information storage and retrieval technique of this invention may be implemented on a general-purpose network host machine such as a personal computer or workstation. Further, the invention may be at least partially implemented on a card (e.g., an interface card) for a network device or a general-purpose computing device.

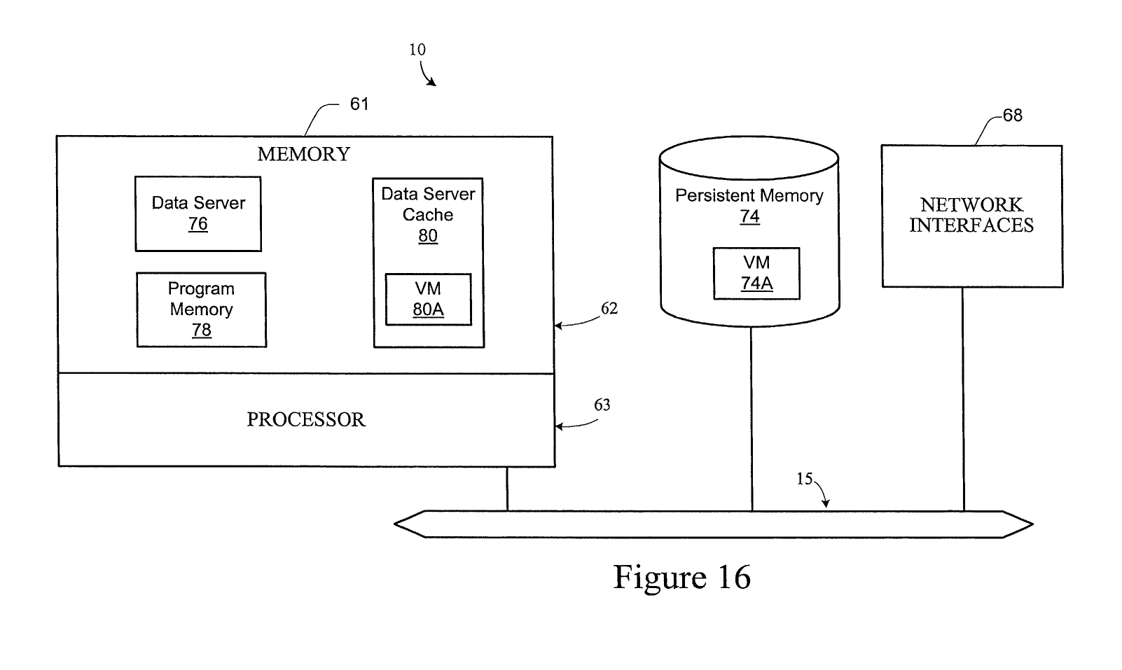

Referring now to FIG. 16, a network device 10 suitable for implementing the information storage and retrieval technique of the present invention includes at least one central processing unit (CPU) 61, at least one interface 68, memory 62, and at least one bus 15 (e.g., a PCI bus). When acting under the control of appropriate software or firmware, the CPU 61 may be responsible for implementing specific functions associated with the functions of a desired network device. When configured as a database server, the CPU 61 may be responsible for such tasks as, for example, managing internal data structures and data, managing atomic transaction updates, managing memory cache operations, performing checkpointing and version collection functions, maintaining database integrity, replicating database information, responding to database queries, etc. The CPU 61 preferably accomplishes all these functions under the control of software, including an operating system (e.g. Windows NT, SUN SOLARIS, LINUX, HPUX, IBM RS 6000, etc.), and any appropriate applications software. It will be appreciated that the combination of non-position updating and simultaneous writer threads in the information storage and retrieval system of the present invention permits real-time maintenance and modification operations to be performed on the database concurrently with database access operations, thereby permitting a high volume of database activity and high concurrency access to the database even during times when portions of the persistent memory are off-line or otherwise inaccessable.

CPU 61 may include one or more processors 63 such as a processor from the Motorola family of microprocessors or the MIPS family of microprocessors. In an alternative embodiment, processor 63 may be specially designed hardware for controlling the operations of network device 10. In a specific embodiment, memory 62 (such as non-volatile RAM and/or ROM) also forms part of CPU 61. However, there are many different ways in which memory could be coupled to the system. Memory block 62 may be used for a variety of purposes such as, for example, caching and/or storing data, programming instructions, etc. For example, the memory 62 may include program instructions for implementing functions of a data server 76. According to a specific embodiment, memory 62 may also include program memory 78 and a data server cache 80. The data server cache 80 may include a virtual memory (VM) component 80A, which, together with the virtual memory component 74A of the non-volatile memory 74, may be used to provide virtual memory functionality to the information storage and retrieval system of the present invention.

According to at least one embodiment, the network device 10 may also include persistent or non-volatile memory 74. Examples of non-volatile memory include hard disks, floppy disks, magnetic tape, optical media such as CD-ROM disks, magneto-optical media such as floptical disks, etc.

The interfaces 68 are typically provided as interface cards (sometimes referred to as “line cards”). Generally, they control the sending and receiving of data packets over the network and sometimes support other peripherals used with the network device 10. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 61 to efficiently perform routing computations, network diagnostics, security functions, etc.

Although the system shown in FIG. 16 illustrates one specific network device of the present invention, it is by no means the only network device architecture on which the present invention can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 62) configured to store data, program instructions for the general-purpose network operations and/or other information relating to the functionality of the information storage and retrieval techniques described herein. The program instructions may control the operation of an operating system and/or one or more applications, for example. The memory or memories may also be configured to include data structures which store object tables, disk pages, disk page buffers, data object, allocation maps, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The invention may also be embodied in a carrier wave travelling over an appropriate medium such as airwaves, optical lines, electric lines, etc. Examples of program instructions include both machine code, such as produced by a compiler, and files containing higher level code that may be executed by the computer using an interpreter.

Although several preferred embodiments of this invention have been described in detail herein with reference to the accompanying drawings, it is to be understood that the invention is not limited to these precise embodiments, and that various changes and modifications may be effected therein by one skilled in the art without departing from the scope of spirit of the invention as defined in the appended claims.

1. A method for implementing system modification operations in an information storage and retrieval system, the information storage and retrieval system including persistent memory configured or designed to store object data, the persistent memory including at least one data file for storing object data, the method comprising:
receiving a first system modification request relating to a first data file, the first data file including a first object stored therein;
implementing the first system modification request, wherein implementation of the first system modification request includes suspending write access to the first data file; and
storing updated information relating to the first object in the persistent memory concurrently while the first system modification request is being implemented.

2. The method of claim 1 wherein said implementing includes closing at least one table space associated with the first data file.

3. The method of claim 1 wherein the information storage and retrieval system corresponds to a non-positional, non-log based information storage and retrieval system.

4. The method of claim 1 wherein the at least one data file includes a disk drive.

5. The method of claim 1 wherein the first data file corresponds to a primary data file;
wherein the system modification request corresponds to a request to add a mirror data file to be associated with the primary data file; and
wherein implementation of the first system modification request further includes copying object data from the primary data file to the mirror data file.

6. The method of claim 5 wherein the addition of the mirror data file is automatically implemented in response to predetermined criteria.

7. The method of claim 1 wherein the first data file corresponds to a primary data file;
wherein the system further includes a mirror data file associated with the primary data file;
wherein the system modification request corresponds to a request to take the primary data file off-line; and.

8. Wherein implementation of the first system modification request further includes swapping assignments of the primary and mirror data files.

9. The method of claim 1 wherein the first data file corresponds to a primary data file;
wherein the system further includes a mirror data file associated with the primary data file; and
wherein the system modification request corresponds to a request to take the mirror data file off-line.

10. The method of claim 1 wherein the first data file corresponds to a primary data file;
wherein the system modification request corresponds to a request to take the primary data file off-line; and
wherein implementation of the first system modification request further comprises copying object data stored on the primary data file to at least one other data file in the persistent memory.

11. The method of claim 10 wherein the first system modification request is implemented without closing a table space of the at least one other data file.

12. The method of claim 1 further comprising implementing the first system modification request concurrently while providing database access to end users.

13. The method of claim 12 wherein said database access includes read access to object data stored on the first data file.

14. The method of claim 12 wherein said database access includes write access to the persistent memory for storing updated object data relating to the first object.

15. The method of claim 12 database access includes write access to at least one other data file in the persistent memory for storing updated information relating to at least one object stored on the first data file

16. The method of claim 1 further comprising performing an update to the first object concurrently while implementing the first system modification request.

17. The method of claim 1 wherein the implementing of the first system modification request is performed in real-time, without blocking access to object data stored in the persistent memory.

18. A computer program product, the computer program product including a computer usable medium having computer readable code embodied therein, the computer readable code comprising computer code for implementing the method of claim 1.

19. A method for implementing system modification operations in an information storage and retrieval system, the information storage and retrieval system including persistent memory configured or designed to store object data, the persistent memory including a first data file and a second data file, the first data file including first object data stored therein, the method comprising:
receiving a first system modification request to remove the first data file from the persistent memory;
implementing removal of the first data file from the persistent memory; and
providing continuous access to object data stored in the persistent memory concurrently during the removal of the first data file.

20. The method of claim 19 further comprising providing continuous data update access to the first object data concurrently during the removal of the first data file.

21. The method of claim 20 wherein the removal of the first data file includes copying the first object data to the second data file.

22. The method of claim 19 wherein said implementing includes closing at least one table space associated with the first data file.

23. The method of claim 19 wherein the information storage and retrieval system corresponds to a non-positional, non-log based information storage and retrieval system.

24. The method of claim 19 wherein the first data file includes a disk drive.

25. The method of claim 19 wherein the removal of the first data file from the persistent memory is accomplished in real-time without taking the information storage and retrieval system off-line.

26. A computer program product, the computer program product including a computer usable medium having computer readable code embodied therein, the computer readable code comprising computer code for implementing the method of claim 19.

27. An information storage and retrieval system comprising:
at least one processor; and
memory;
the memory including persistent memory configured or designed to store object data;
the system being configured or designed to receive a first system modification request relating to a first data file, the first data file including a first object stored therein;
the system being further configured or designed to implement the first system modification request, wherein implementation of the first system modification request includes suspending write access to the first data file; and
the system being further configured or designed to store updated information relating to the first object in the persistent memory concurrently while the first system modification request is being implemented.

28. The system of claim 27 being further configured or designed to close at least one table space associated with the first data file during implementation of the first system modification request.

29. The system of claim 27 wherein the information storage and retrieval system corresponds to a non-positional, non-log based information storage and retrieval system.

30. The system of claim 27 wherein the at least one data file includes a disk drive.

31. The system of claim 27 wherein the first data file corresponds to a primary data file;
wherein the system modification request corresponds to a request to add a mirror data file to be associated with the primary data file; and
wherein implementation of the first system modification request further includes copying object data from the primary data file to the mirror data file.

32. The system of claim 31 wherein the addition of the mirror data file is automatically implemented in response to predetermined criteria.

33. The system of claim 27 wherein the first data file corresponds to a primary data file;
wherein the system further includes a mirror data file associated with the primary data file;
wherein the system modification request corresponds to a request to take the primary data file off-line; and.

34. Wherein implementation of the first system modification request further includes swapping assignments of the primary and mirror data files.

35. The system of claim 27 wherein the first data file corresponds to a primary data file;
wherein the system further includes a mirror data file associated with the primary data file; and
wherein the system modification request corresponds to a request to take the mirror data file off-line.

36. The system of claim 27 wherein the first data file corresponds to a primary data file;
wherein the system modification request corresponds to a request to take the primary data file off-line; and
wherein implementation of the first system modification request further comprises copying object data stored on the primary data file to at least one other data file in the persistent memory.

37. The system of claim 36 wherein the first system modification request is implemented without closing a table space of the at least one other data file.

38. The system of claim 27 being further configured or designed to implement the first system modification request concurrently while providing database access to end users.

39. The system of claim 38 wherein said database access includes read access to object data stored on the first data file.

40. The system of claim 38 wherein said database access includes write to the persistent memory for storing updated object data relating to the first object.

41. The system of claim 38 wherein said database access includes write access to at least one other data file in the persistent memory for storing updated information relating to at least one object stored on the first data file

42. The system of claim 27 being further configured or designed to perform an update to the first object concurrently while implementing the first system modification request.

43. The system of claim 27 being further configured or designed to implement the first system modification request in real-time, without blocking access to object data stored in the persistent memory.

44. An information storage and retrieval system comprising:
at least one processor; and
memory;
the memory including persistent memory configured or designed to store object data;
the system being configured or designed to receive a first system modification request to remove the first data file from the persistent memory;
the system being further configured or designed to implement removal of the first data file from the persistent memory; and
the system being further configured or designed to provide continuous access to object data stored in the persistent memory concurrently during the removal of the first data file.

45. The system of claim 44 being further configured or designed to provide continuous data update access to the first object data concurrently during the removal of the first data file.

46. The system of claim 45 wherein the removal of the first data file includes copying the first object data to the second data file.

47. The system of claim 44 being further configured or designed to close at least one table space associated with the first data file during implementation of the first system modification request.

48. The system of claim 44 wherein the information storage and retrieval system corresponds to a non-positional, non-log based information storage and retrieval system.

49. The system of claim 44 wherein the first data file includes a disk drive.

50. The system of claim 44 being further configured or designed to implement removal of the first data file from the persistent memory in real-time without taking the information storage and retrieval system off-line.

51. A computer program product for implementing system modification operations in an information storage and retrieval system, the information storage and retrieval system including persistent memory configured or designed to store object data, the persistent memory including at least one data file for storing object data, the computer program product comprising:
a computer usable medium having computer readable code embodied therein, the computer readable code comprising:
computer code for receiving a first system modification request relating to a first data file, the first data file including a first object stored therein;
computer code for implementing the first system modification request, wherein implementation of the first system modification request includes suspending write access to the first data file; and
computer code for storing updated information relating to the first object in the persistent memory concurrently while the first system modification request is being implemented.

52. The computer program product of claim 51 wherein said implementing code includes computer code for closing at least one table space associated with the first data file.

53. The computer program product of claim 51 wherein the information storage and retrieval system corresponds to a non-positional, non-log based information storage and retrieval system.

54. The computer program product of claim 51 wherein the at least one data file includes a disk drive.

55. The computer program product of claim 51 wherein the first data file corresponds to a primary data file;
wherein the system modification request corresponds to a request to add a mirror data file to be associated with the primary data file; and
wherein the computer code for implementing the first system modification request includes computer code for copying object data from the primary data file to the mirror data file.

56. The computer program product of claim 55 wherein the addition of the mirror data file is automatically implemented in response to predetermined criteria.

57. The computer program product of claim 51 wherein the first data file corresponds to a primary data file;
wherein the system further includes a mirror data file associated with the primary data file;
wherein the system modification request corresponds to a request to take the primary data file off-line; and.

58. Wherein the computer code for implementing the first system modification request includes computer code for swapping assignments of the primary and mirror data files.

59. The computer program product of claim 51 wherein the first data file corresponds to a primary data file;
wherein the system further includes a mirror data file associated with the primary data file; and
wherein the system modification request corresponds to a request to take the mirror data file off-line.

60. The computer program product of claim 51 wherein the first data file corresponds to a primary data file;
wherein the system modification request corresponds to a request to take the primary data file off-line; and
wherein the computer code for implementing the first system modification request comprises computer code for copying object data stored on the primary data file to at least one other data file in the persistent memory.

61. The computer program product of claim 60 further comprising computer code for implementing the first system modification request without closing a table space of the at least one other data file.

62. The computer program product of claim 51 further comprising computer code for implementing the first system modification request concurrently while providing database access to end users.

63. The computer program product of claim 62 wherein said database access includes read access to object data stored on the first data file.

64. The computer program product of claim 62 wherein said database access includes write access to the persistent memory for storing updated object data relating to the first object.

65. The computer program product of claim 62 database access includes write access to at least one other data file in the persistent memory for storing updated information relating to at least one object stored on the first data file

66. The computer program product of claim 51 further comprising computer code for performing an update to the first object concurrently while implementing the first system modification request.

67. The computer program product of claim 51 further comprising computer code for implementing the first system modification request in real-time, without blocking access to object data stored in the persistent memory.

68. A system for implementing system modification operations in an information storage and retrieval system, the information storage and retrieval system including persistent memory configured or designed to store object data, the persistent memory including at least one data file for storing object data, the computer program product comprising:
means for receiving a first system modification request relating to a first data file, the first data file including a first object stored therein;
means for implementing the first system modification request, wherein implementation of the first system modification request includes suspending write access to the first data file; and
means for storing updated information relating to the first object in the persistent memory concurrently while the first system modification request is being implemented.

69. The computer program product of claim 68 wherein the information storage and retrieval system corresponds to a non-positional, non-log based information storage and retrieval system.

70. The computer program product of claim 68 further comprising means for performing an update to the first object concurrently while implementing the first system modification request.

71. The computer program product of claim 68 further comprising means for implementing the first system modification request in real-time, without blocking access to object data stored in the persistent memory.
